(19) United States
(12) Patent Application Publication
(10) Pub. No.: US 2021/0383444 A1
(43) Pub. Date: Dec. 9, 2021

(54) AUTOMATED NEGOTIATION METHOD AND COMPUTER PROGRAM PRODUCT FOR IMPLEMENTING SUCH METHOD

(71) Applicant: PrivateDeal SA, Lausanne (CH)

(72) Inventors: Lucien Mauguin, Renens (CH); Isabelle Mauguin, Renens (CH)

(21) Appl. No.: 17/303,655

(22) Filed: Jun. 3, 2021

(30) Foreign Application Priority Data
Jun. 4, 2020 (CH) 20200000665

(51) Int. Cl. G06Q 30/06; G06Q 30/02; G06N 3/08; G06F 9/445

(52) U.S. Cl. CPC G06Q 30/0611; G06Q 30/0641; G06F 9/44526; G06N 3/08; G06Q 30/0283

(57) ABSTRACT

A computer-implemented method comprising:

presenting on a web site an offer for an object;

receiving on said web site a first proposal from a potential buyer for said object with a first price;

retrieving in said application server buyer parameters corresponding to said potential buyer;

retrieving in said application server buyer-independent parameters including parameters of the object, parameters and price of other objects, and data from external sources;

determining in said application server a second offer for said object, said second price being determined with an artificial intelligence engine based on said psychological price and on said buyer parameters and on said buyer independent parameters;

proposing said second offer to said buyer;

receiving from said buyer a second proposal with a third price;

determining in said application server a third offer for said object, wherein said third offer includes a fourth price for a modified object.

### TECHNICAL DOMAIN

The present disclosure concerns a method for the automatic negotiation of the price of an object proposed for sale on an online web site.

### RELATED ART

There are countless web sites for purchasing objects (products or services) on the Internet. Most objects offered for sale on the Internet are sold at a fixed price set by the merchant. The price may for example be fixed based on production costs and desired margin, and/or depend on the competition for the product.

Technology is more and more involved in this process and has been widely used in order to determine automatically and dynamically the price of an object.

Flight tickets or hotel reservations are often sold months in advance at an initial price which is then automatically adjusted according to market response. A drawback of those methods is the time that might be needed in order to determine the appropriate market price of the object. Therefore, many objects are initially sold at price which is either too low, resulting in lost margins, or too high, resulting in low volume of sales.

Forward Auction (Bidding) methods have also been used in order to determine the price of an object and to sell it. In that case, if a merchant wants to sell an object, he proposes an initial price and gets several potential buyers to bid on it during a predefined time period. The highest bid at the end of that period is the amount at which the final amount is decided. Many automatic forward auction platforms have been proposed and operated with various software-based methods on the Internet, notably for the sale of second-hand goods or other objects available in limited quantities.

Reverse Auction (Reverse Bidding) methods are also known where a potential buyer who wants to purchase an object ask several sellers to reverse bid for the object. For example, the bid starts at an initial price and each merchant can decrease the price, until no merchant decreases anymore.

Direct Negotiation methods are also known; for example, a traveller who wants to book an hotel room can call the hotel and propose a price lower than the public displayed price. The seller (hotel) accepts or not, in one or several iterations. There are no several buyers nor several sellers competing against one another. Although direct negotiations are attractive both for the buyer and for the seller, conducting an efficient negotiation and finding appropriate terms of the negotiation is a difficult task which requires a good understanding of the desires and psychology of the potential buyer. Therefore, efficient direct negotiation is most often performed through human operators, resulting in a time-consuming, expensive and unpredictable process as well as to an increased risk of fraud, errors or unauthorized commitments.

Various attempts have been made in order to automate the direct negotiation between a selling platform and a buyer on the Internet. Unfortunately, existing solutions often require a cumbersome process for the potential buyer who might be required to iterate many successive offers. Most automated systems also result in a transaction price which is either too low, resulting in lost margins for the seller, or too high, resulting in aborted sales. In addition, existing solutions typically require many human interactions from the seller in order to define negotiation parameters or even during each negotiation.

Semi-automated systems are also used where a computer system assist a human operator during a direct negotiation, resulting often in less interactions between buyers and sellers and reduced costs. However, a human operator is still required during each interaction.

### SUMMARY

An aim of the present disclosure is the provision of a method and system that overcomes the shortcomings and limitations of the state of the art.

There is an aim of the present disclosure to propose an improved method and system for automating such direct negotiation of the price of an object offered for sale on the Internet.

In particular, an aim of the disclosure is to propose a method and system that requires no interactions from the buyer and from the seller in order to determine a transaction price that is acceptable for both.

The features of the disclosure may imply in particular an entirely new infrastructure and access or processing of data according to an entirely new method.

According to the disclosure, these aims are attained by the object of the attached claims, and especially by a computer-implemented method for the automatic negotiation of the price of an object proposed on an on-line web site by a seller to a potential buyer, comprising:

providing an online sale server controlled by said seller, said online sale server comprising a database of objects for sale, each object being associated in said database with object parameters, said online sale server being programmed for presenting on the Internet a web site with a list of said objects for sale;

providing to a plurality of sellers an application server distinct from said online sale server and programmed or trained for determining a buyer independent psychological price for an object, said psychological price being dependent on the sale price of said object during previous transactions, said application server including a buyer parameters database, said buyer parameters depending on buyers profiles and buyers history of negotiations and/or transactions with a plurality of said sellers;

presenting on said web site a first offer for said object;

receiving on said web site a first proposal from the potential buyer for said object with a first price;

transmitting said first proposal to said application server;

retrieving in said application server buyer parameters corresponding to said potential buyer;

retrieving in said application server buyer-independent parameters including parameters of the object, parameters and price of other objects, and data from external sources;

determining in said application server a second offer for said object, wherein said second offer includes a second price higher than said first price, said second price being determined with an artificial intelligence engine based on said psychological price and on said buyer parameters including said buyer history of negotiations and/or transactions and on said buyer independent parameters;

proposing said second offer to said buyer;

receiving from said buyer a second proposal with a third price;

transmitting said second proposal to said application server;

determining in said application server a third offer for said object, wherein said third offer includes a fourth price for said object or for a modified object.

The artificial intelligence engine may be trained with the history of transactions or negotiations of the potential buyer with the seller and with other sellers. The method also comprises a step of training this engine with the parameters and outcome of the current negotiation.

One advantage of providing an application server distinct from the online sale server operated by the seller is that each seller can benefit from a better knowledge of each potential buyer, including parameters of the buyer obtained or derived from previous negotiations between that buyer and other sellers. For example, when a potential buyer negotiates with a first seller in order to buy a product, such as an hotel room, the artificial intelligence engine of the application server learns buyer parameters of the buyer and uses them for making future negotiations between that buyers and other sellers more efficient. As a result, less iterations are needed in order to determine negotiations terms that are acceptable for the buyer and for the seller, resulting in a reduced amount of data exchanged and faster negotiation.

Another benefit of providing an application server distinct from the online sale server operated by the seller is that sellers only need to have a web site for presenting their objects, but don't need to build and maintain the technologically complex infrastructure that is needed for analysing the proposals from the potential buyers and proposing appropriate counter offers.

Additionally, the independent application server preserves the privacy and confidentiality of at least some of the buyers' parameters, which are not exchanged between different buyers.

The automatic determination of the second and third offers thus relies on parameters, including said psychological price, buyer profiles and buyer transaction or negotiation histories and buyer independent parameters, stored by the application server, and on the training of an artificial intelligence engine with those parameters.

The method might comprise the steps of retrieving in said application server seller parameters corresponding to said seller;
said second price might be determined with the artificial intelligence engine based on said buyer parameters and on said seller parameters.

The seller parameters might include the number of remaining objects. For example, the application server might propose a second price for an hotel room that might be different if the hotel has many empty rooms at a given date, only few empty rooms, or no available rooms at all.

Each object may be associated in said database with a floor price.

The floor price and corresponds to the minimal price at which the seller accepts to sell the object.

This floor price might be determined by the seller.

Alternatively, this floor price might be determined automatically, for example by the artificial intelligence engine, taking into account parameters in relation with the object, such as the number of remaining objects, the geographical location of the object, and/or parameters retrieved from external servers such as weather forecasts or agendas (special event at the object location, public holiday or school holiday around the date of delivery or use of the object . . .),etc. This floor price is not dependent from a particular potential buyer.

The floor price might be identical for several negotiations, and updated, for example periodically, on request by the seller, or when a predetermined event triggers such an update.

In an embodiment, the first offer presented on said web site is presented with a public price higher than said floor price and higher than said psychological price.

The second offer includes a second price at which the object is offered for sale which may be higher than said first price and said floor price, but lower than said public price. The third offer includes a fourth price at which the object is offered for sale, which fourth may be higher than said third price and said floor price, but lower than said public price.

In another embodiment, no public price is displayed initially with the first offer, and the potential buyer is invited to propose his own price that the application server can either accept or refuse. This method might be useful for determining the perceived value of the object, i.e., the price at which potential buyers accept to buy the object.

The buyer transaction or negotiation history might include a long-term history of transaction of a buyer, including for example transactions and/or negotiations performed by the potential buyer more than one month ago and possibly related to the acquisition of different objects.

The buyer transaction or negotiation history might include a short-term history of transaction of a buyer, including for example transactions and/or negotiations performed by the potential buyer less than 24 hours ago and related to the acquisition of the same object, or of different objects for the same need. For example, the second and third offer might be based on the understanding of the type of object that the potential buyer is currently looking for.

The automatic determination of the second and third offers may also depend on parameters stored by the online sale server, and/or on parameters retrieved from external data sources. For example, the buyer-independent parameters might include parameters retrieved from external servers such as weather forecasts or agendas.

The automatic determination of the second and third offers may also depend on the number of simultaneous views and/or bids for the object during the negotiation, as determined by the application server.

A fast, efficient, time and energy-saving negotiation is also achieved thanks to the option for the application server to propose an offer for a modified object. Therefore, the terms of the negotiation do not depend on the price only, but also on a modified object. As an example, the application server may propose an offer for an entirely different object (for example replacing an offer for a hotel room by an offer for a different hotel room) and/or non-cash benefits (for example proposing the same room but with a free access to a spa).

The method might comprise a step of determining the price and/or the cost of said modified object. For example, the determination of the third offer might include a determination of the cost or perceived value of the non-cash benefits, in order to propose an offer which is likely to be acceptable for both parties. This third offer might include a modified object, with a fourth price equal to the third price previously received through the second proposal of the buyer for the object initially proposed for sale. Alternatively, this third offer might include a modified object with a fourth price slightly higher than the third price, for example a fourth price contained in the range from the third price and 1.1 the third price, or in the range from the third price and 1.05 the third price.

The selection of a modified object might be buyer-dependant. For example, the artificial intelligence engine might determine that a particular potential buyer is likely to accept an offer if it includes an access to a spa or other non-cash benefits that might convince the potential buyer.

The selection of a modified object might depend on one or more parameters of the buyer's profile, such as his age, gender, nationality, and on his history of transactions and/or negotiations, etc. For example, the artificial intelligence system might determine that Swiss buyers are more likely to be convinced with a free access to the spa while Mexican buyers are more likely to enjoy an upgrade to a larger room.

The psychological price of said object may depend on an average of the price at which said object was sold during previous transactions.

Each object may be associated with an implicit or explicitly stored period of validity that indicates how long a proposed price for an object is relevant and should be considered for computing said psychological price. This period might depend on the obsolescence of the object. As an example, a price proposed for an hotel room is only relevant for a given date, because the psychological price at any different date, for example on another day of the week or another period of the year, might be completely different. A price for a piece of electronic equipment might be relevant for a few weeks or months, depending on the obsolescence rate of that equipment.

The psychological price may be based on an average or median of the price at which said object was sold or proposed during previous transactions during the period of validity around the date of delivery or use of the object. For instance, the psychological price for an hotel room at a given date in the future is based on an average of the price offered for that room, or rooms of the same category, at the same date.

In order to obtain a trustworthy and reliable value for that psychological price, this average may not take into account extreme lowest and highest prices proposed during transactions. Therefore, the psychological price reflects the buyer's demand, giving information on the price which is in average or typically acceptable for potential buyers for a certain object, at a certain time. This psychological price is not buyer-dependent.

The buyer dependant parameters might include cookies stored in a buyer equipment.

The buyer dependant parameters might include a buyer profile stored in the online sale server.

The buyer dependant parameters might include a buyer profile stored in the application server.

The method might comprise a step of classifying said potential buyer according to the type of negotiator he is and determining said second and said third offer depending on said type of negotiator. For example, an artificial intelligence engine might determine if the buyer is a gambler or a more conservative negotiator, and/or determine his purchase capacity.

The method might include a step of executing a plug-in in said online sale server in order to communicate with said application server and to present said second and said third offer.

The method might also include a step of executing a plug-in in said online sale server in order to communicate with said application server and to present to the buyer a personalized message. This message may be an incentive message addressed to the buyer in order to give to him/her arguments so that the negotiation succeeds and the sale of the objects takes place. This message may be an incentive message which is a buyer dependent message. Such a message takes optionally into consideration the buyer's profile. Such a message may be displayed on a web page on the buyer's equipment. This message is presented to the buyer between a proposal made by the buyer and an offer made by the application server. This message can be presented after an offer made by the application server and before the next proposal made by the buyer. For example, this message explains why the price of the offer just made is quite different from the earlier presented price of the earlier proposal made by the buyer to push the buyer to make a next proposal with a substantive higher price. This message can be presented after a proposal made by the buyer and before the next offer made by the application server. For example, this message explains why the price of the proposal just made by the buyer is considered too low by the seller to push the buyer to consider seriously the forthcoming next offer.

The disclosure is also related to a computer program product including a program arranged for causing an application server to perform a method comprising the above-mentioned steps that can be performed by the application server.

### SHORT DESCRIPTION OF THE DRAWINGS

Exemplar embodiments of the disclosure are provided in the description and illustrated by the drawings in which:

FIG. 1 illustrates a simplified block schema of a buyer equipment with suitable hardware and software modules for performing a negotiation.

FIG. 2 illustrates a simplified block schema of an on-line sale server with suitable hardware and software modules for presenting a web site and accessing an application server in order to perform a negotiation.

FIG. 3 illustrates a simplified block schema of an application server with suitable hardware and software modules for executing agents in order to perform a negotiation.

FIG. 4 illustrates a simplified block schema of a system with a buyer's equipment, an on-line sale server, an application server and an external data server.

FIG. 5 illustrates an example of web page displayed on a buyer's equipment during a negotiation.

### DETAILED DESCRIPTION

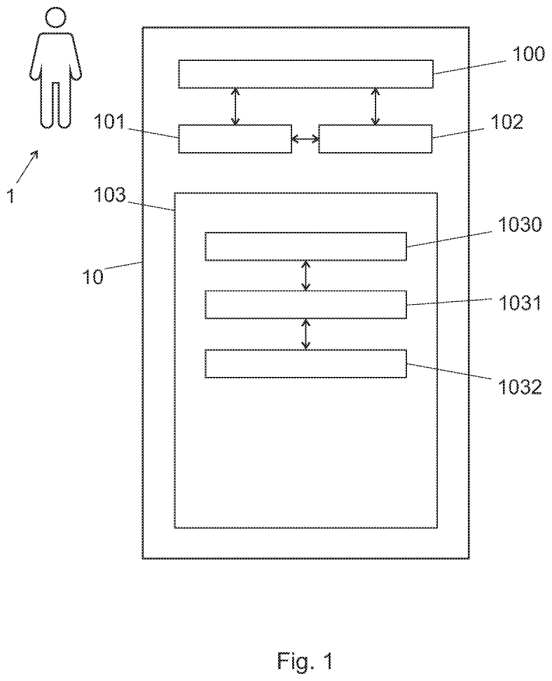

FIG. 1 schematically illustrates a buyer 1 with a buyer's equipment 10 such as a personal computer, smartphone, tablet, smart tv or the like. The equipment includes a user interface 100 comprising for example a display, loudspeaker, microphone, keyboard, etc. I/O components 102, such as for example a WIFI, Ethernet or cellular interface can connect the equipment 10 to an external network such as a LAN or the Internet. The equipment is controlled by a processor 101 accessing a memory 103.

The memory 103 includes an operating system 1030, such as Windows, IOS, Android, Unix, etc. A browser 1031 can be executed on the operating system for navigating the Internet and accessing the web site of a seller. Alternatively, or an addition, a dedicated app can be stored in memory 103 and executed by the processor for accessing to the offer of the seller. The browser and/or app 1031 can store buyer dependent parameters, such as a buyer profile with preferences, history of negotiations, history of navigation, etc. Some of the parameters of the buyer profile may be stored as cookies 1032 of the browser.

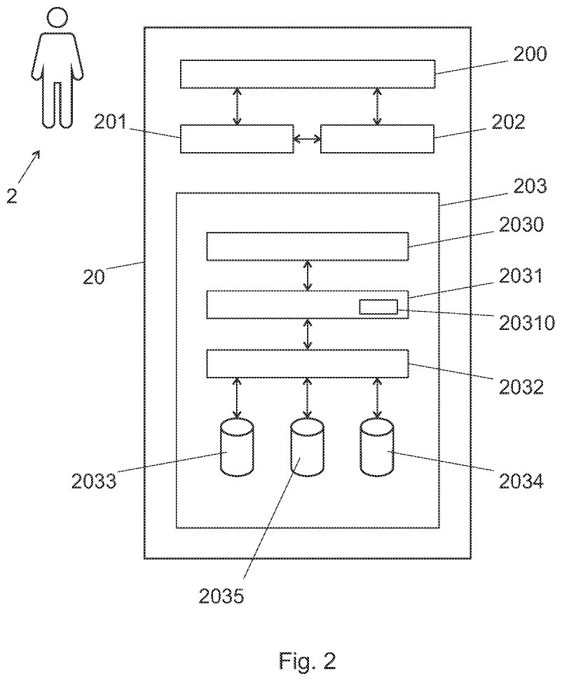

FIG. 2 schematically illustrates a seller 2 with an online sale server 20. The sale server may be a physical server such as a Windows or Unix server, a virtual server, a cloud-based server, a group of servers, or any other suitable hardware and software infrastructure for operating and presenting a web site.

The server 20 might include a user interface 200 comprising for example a display, loudspeaker, microphone, keyboard, etc. I/O components 202, such as for example a WIFI, Ethernet or cellular interface can connect the server 20 to an external network such as a LAN or the Internet. The server is controlled by at least one processor 201 accessing a memory 203.

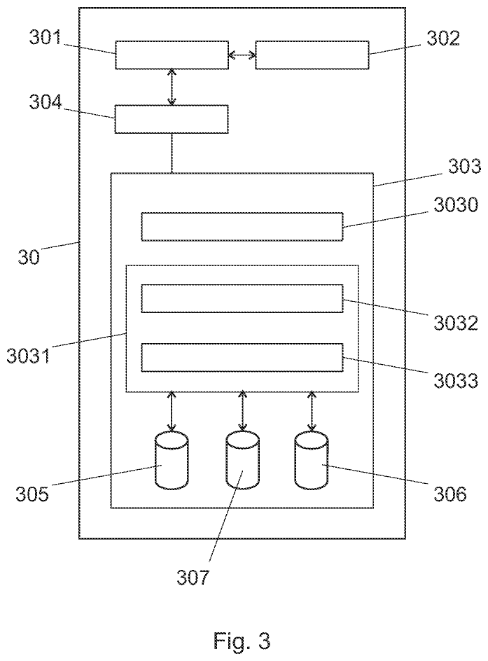

The memory 203 includes an operating system 2030, such as Windows, Unix, etc. A web site 2031 might be hosted in the memory 203 or built with a software in that memory and presented on the Internet to potential buyers. The web site 2031 might use one or a plurality of plug-ins 20310 for accessing an application server 30 (FIG. 3) and presenting on the web site content prepared by this application server.

The web site 2031 may be based on a content management system (CMS) 2032 such as WordPress, Joomla, Drupal, etc. The content presented on the web site depends on a list 2033 of objects for sale, including object parameters/features, image, description, floor price, and/or initial price, etc) and on a list 2034 of buyer parameters including for example buyers' s profiles with preferences, address, history of commands, etc. The list 2034 only includes parameters of buyers having interacted with the web site 2030. Possibly, the content presented on the web site also depends on a list 2035 in a seller database with specific seller parameters including for example seller' s profiles with preferences, address, history of commands, etc.

The memory 203 might also include seller parameters, including for example the number of available rooms of any time at different dates.

FIG. 3 schematically illustrates an application server 30. The application server may be a physical server such as a Windows or Unix server, a virtual server, a cloud-based server, a group of servers, or any other suitable hardware and software infrastructure for.

The application server 30 might include I/O components 302, such as for example a WIFI, Ethernet or cellular interface can connect the server 30 to an external network such as a LAN or the Internet. The server is controlled by at least one processor 301 accessing a memory 303. At least one artificial intelligence (AI) engine 304 is included or accessible by the application server 30. The AI engine might comprise a hardware and/or software module. It might be based on any type of self-learning system, such as for example a neural network, etc.

The memory 303 includes an operating system 3030, such as Windows, Unix, etc. One or a plurality of software programs in memory 303 might be executed by the processor 301. In one embodiment, a plurality of software agents 3031 in memory 303 might be executed concurrently, whereas each agent handles one negotiation with a specific potential buyer. Each agent can execute a plurality of software modules, such as a psychological price determination module 3032, a next offer determination module 3033, etc. The agents 3031 can access the AI engine 304.

The agents 3031 can further access a database of objects 305 with parameters of objects sold or offered for sale by a plurality of different sellers, and a database of buyers 306 with profiles of buyers having accessed a plurality of web sites from different sellers. The buyers in database 306 might be anonymized

The agents 3031 can further access a database of sellers 307 with a history of transactions with each seller. The sellers in database 307 might be anonymized.

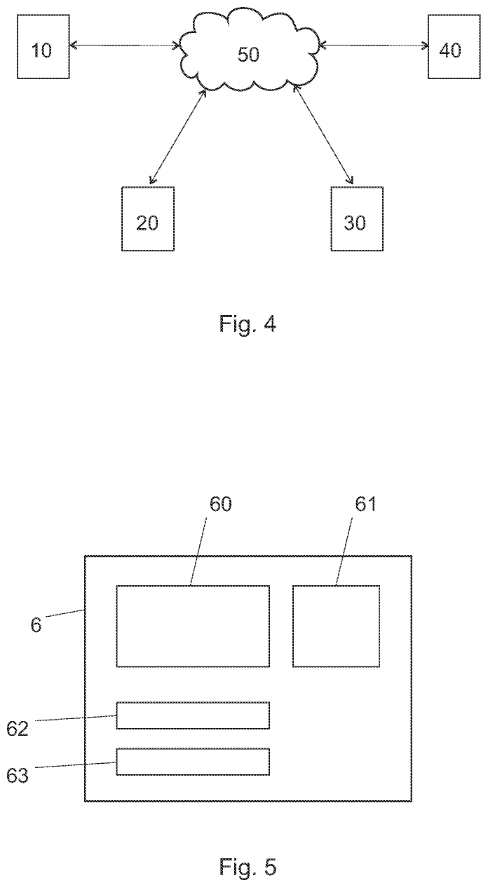

FIG. 4 schematically illustrates a system comprising one or a plurality of buyers' equipment 10, one or a plurality of online sale servers 20, an application server 30, and one or a plurality of external databases 40. All the components are mutually connected over a network 50 such as the Internet. The external databases 40 might include public sources with data relevant for the price of the objects sold through the servers 20, such as for example weather forecasts, agenda of events, political and business information, web sites for the sale of similar objects, etc.

FIG. 5 schematically illustrates one example of page 6 that might be presented on the display 100 of a buyer's equipment 10 during a transaction. The page might include a description of the object, possibly with one or several images 60 and one description 61.

A public price for the object may be displayed in a field 62. The field 63 might be used by the potential buyer for entering a proposal, for example a lower proposed price for this object.

In another embodiment, no public price is displayed initially in field 62, and the potential buyer is invited to propose his price in field 63 without knowing the expectations from the seller.

We will now describe an example of a method that can be carried out with the system of FIG. 4.

A seller 2 wishing to sell one or a plurality of objects, such as physical products (such as for example new cars, second-hand cars, luxury products such as jewelry, watches or other goods), services including hotel rooms nights, flight tickets, rental cars, etc. first needs to set up an online sale server 20 as illustrated on FIG. 2 and to connect this server to the Internet in order to expose a web site 2031 for selling his objects. The sale server 20 includes or can access a database 2033 of objects for sale, including or each object a description with a list of object parameters that can determine the price of the object, optionally at least one image, and a floor price, i.e., the minimal price fixed by the seller and at which the seller accepts to sell the object. The database 2033 may also include an indication of the number of objects of each category that remain available.

The seller then needs to install a plug-in 20310, such as a plug-in for the CMS system 2032, in order to connect the sale server to an application server 3 distinct from the online sale server 2. The plug-in 20310 is responsible for prompting potential buyers 1 during a negotiation to enter price proposals for the acquisition of an object, and for displaying a counter-offer (new offer, namely second or third offer) prepared by the application server 3 depending on buyer-dependent and buyer-independent parameters in the online sale server 2 and/or in the application server 3. This plug-in 20310 may be responsible for displaying the potential buyer a personalized message which is presented to the buyer between a proposal made by the buyer and an offer made by the application server.

A software module 3031 in the application server 3 determines a so-called “psychological price” for at least some of the objects offered for sale by the seller. The psychological price is a buyer-independent parameter that indicates the price that an average buyer interested in that object might be willing to pay at that time for the acquisition of the object at a given date. This psychological price is determined based on an average the price at which that object was sold during previous transactions, as stored in database 305. The average might be limited to proposals made for the acquisition during an explicit or implicit validity period.

Additionally, an artificial intelligence engine, such as a neural network or other type of self-learning classifier, might be trained with parameters and prices from previous sales and used for determining a predictive price of the object, i.e., the price that potential buyers might be willing to pay. This predictive price might be displayed to the seller and help him to determine his floor price or initial price for example.

The plug-in initially optionally displays a public price 62 in relation with the object; this public price, which is typically higher than said floor price and higher than said psychological price, might be determined by the application server, for example depending on said psychological price, and/or fixed by the seller 2. The psychological price might be fixed or adapted dynamically, for example depending on the offer and demand for similar objects.

Alternatively, no public price is displayed initially.

A potential buyer interested in the acquisition of the object connects to the web site 2031 with the browser or app in his buyer's equipment 10, sees the description 61 and image 60 of the object, and see the public price 62 (if displayed) with an invitation to enter a first proposal in the field 63. The first proposal indicates a price, usually lower than the public price, that the potential buyer is willing to pay for the object.

The first proposal is received by the plug-in 20310 and transmitted to a next offer determination module 3033 in the application server 30. The module determines if the proposal can be accepted or which counteroffer should be proposed.

The application determines the profile of the potential buyer from a database 306. Elements of the profile might also be transmitted by the plug-in 3031. The buyer profile includes for example biographic parameters such as nationality, domicile, gender, age, profession, etc (when available), as well as history of previous transactions and/or negotiations of that potential buyer with the same or with other sellers. The profile might also include a classification of the potential buyer determined from his biography and/or transaction or negotiation history. This classification might be obtained with an automatic classifier, such as a neural network. It might indicate for example a type of behaviour of the potential buyer during a negotiation. As an example, some potential buyers might be classified as “gamblers” if they are likely to make a first proposal remote from the maximal price they could accept, or as “conservative” if they are more likely to make a first proposal closer to this maximal price. Intermediate values might be defined. Multiple classifications along different axis might be defined for a single potential buyer.

If the first proposal entered by the potential buyer is high enough, for example if it is higher than the floor price, or if it exceeds that floor price by a minimum margin, the proposal might be immediately accepted and the buyer is then invited to confirm the acquisition and pay. Therefore, potential buyers are not forced to iterate several times during the negotiation if they quickly make an acceptable proposal from the first proposal. Alternatively, this first proposal is only accepted if higher than the psychological price, or if it exceeds that psychological price by a minimum margin.

According to another possibility, the decision to accept or not immediately a proposal might also be buyer dependent and depends for example on the buyer's profile, including for example his classification and/or history of previous negotiations. Moreover, the decision to accept or not immediately might depend on buyer-independent parameters, including data from external sources. As an example, a proposal for an hotel room might be accepted if the weather forecast for the relevant days are bad, suggesting a low probability that the room will be sold to another buyer, and refused if the weather forecasts are better, suggesting a probable high demand on that day. The decision to accept or refuse a proposal might be determined by an algorithm, for example through a comparison with a price threshold, such as said floor price, and/or taken by an artificial intelligence engine.,

If the first proposal is refused, the module 3033 in the application server 30 determines a second offer for the object. The second offer includes a second price higher than the floor price and higher than the first price proposed by the potential buyer, but lower than the initially displayed public price. The second offer is determined with the artificial intelligence engine 304 based on the psychological price, the buyer parameters in database 305 or retrieved from the plug-in, and on buyer independent parameter including parameters of the object and parameters from external databases 40. This second offer might also be determined based on the seller parameters in database 307.

The second offer may also be determined with the artificial intelligence engine 304 based on seller parameters in database 2033, such as for example the number of remaining objects. For example, the application server might propose a second price for an hotel room that will be different if the hotel has many empty rooms at a given date, only few empty rooms, or no available rooms at all.

The second price determined by the module 3033 is transmitted to the plug-in and displayed by the web site to the potential buyer.

If the potential buyer 1 accepts the second price, the iterative negotiation is terminated, and the potential buyer is invited to pay. Otherwise, the potential buyer can enter a second proposal with a third price in the field 63, that the module 3033 will either accept or reply with a second counteroffer (third offer). The process is iteratively repeated until an offer or a proposal is accepted.

In an embodiment, the maximal number of iterations is limited to N iterations, for example 3 iterations. The maximal number of iterations might be different than 3. The maximal number of iterations might be a parameter set by the seller, and different from one seller to the next. This maximal number N of iterations might be the same or might be a parameter set by the buyers; for example, one buyer might prefer a reduced number of iterations (even if he has to pay a higher price) while another buyer might prefer a longer transaction involving a larger maximal number N of iterations. In that case, the potential buyer can either accept the initial public price, or any successive price until the Nth iteration; if he refuses that Nth offer, the process is terminated, and the potential buyer cannot buy that object anymore.

According to one aspect, after the first iteration the next offer determination module 3033 can make an offer in which not only the offered price can be modified, but also the object that is offered for sale.

The modification of object can for example include a replacement of an object by a different object. As an example, the module 3033 can propose in any counteroffer to replace an hotel room or flight ticket by an alternative hotel room resp. flight ticket for the same price or for a different price.

The modification of object can for example include an offer for the sale of the initial object with an additional object, such as non-cash benefit. As an example, the module 3033 can propose in any counteroffer to add a free entry to a spa or a free parking ticket to a hotel night. As another example, if the object for sale is a flight ticket, the module 3033 can propose in any counteroffer to add as non-cash benefit an on-board service such as drinks, or the possibility to board with an additional luggage, or the possibility to use an airport lounge, etc. As another example, if the object for sale is a car, the module 3033 can propose in any counteroffer to add as non-cash benefit an insurance, a garage service or additional accessories or equipment. As another example, if the object for sale is a physical product, the module 3033 can propose in any counteroffer (new offer) to add as non-cash benefit a servicing, an extended warranty, or an additional accessory or equipment.

The module 3033 optionally determines the price, perceived value and/or cost of the modified object, in order to make a counteroffer with a modified object that is likely to be acceptable by the buyer and by the seller. The cost might be determined by the seller and indicated in database 2033. The price might be the public price of the modified object, as displayed on the web site and indicated in database 2033. The perceived value might be determined by the application server, possibly with an artificial intelligence engine, based on previous offers with or without that modification that were either accepted or refused.

The selection of a modified object might be buyer dependent. As an example, an artificial intelligence engine trained with previous negotiations of the buyer or of comparable buyers might determine the modification that will be most likely to trigger a sale at minimal cost for the seller.

The selection of a modified object might depend on one parameter of the buyer's profile, such as his age, gender, nationality etc. For example, the artificial intelligence system might determine that Swiss buyers are more likely to be convinced with a free access to the spa while Mexican buyers are more likely to enjoy an upgrade to a larger room.

According to one aspect, the potential buyer receives personalized messages as motivating message for (one of) the next step to be a proposal or an offer acceptable both by the buyer and by the seller. Those personalized messages may be established by the application server. Those personalized messages can be displayed graphically on the buyer's equipment 10, in parallel to the fields 62 and 63, and to the image 60 and description 61 of the object, on the page 6 presented on the display 100. Alternatively, those personalized messages can be audio displayed on the buyer's equipment 10 through loudspeakers. If the message is presented after a proposal made by the buyer and before the next offer made by the application server, for example, this message informs the buyer that the price of this proposal is or might be considered too low to the seller and whenever the next proposal is not significantly higher (higher price), the negotiation might stop after his/her next proposal.

If the message is presented after an offer made by the application server and before the next proposal made by the buyer, for example, this message informs the buyer that whenever his/her next proposal is too far away from the offer just received (namely a price difference between the buyer next proposal and the price of the offer just received is considered too big by the system/the seller), the negotiation might stop after his/her next proposal. Another message can push the buyer to make a next proposal within a reasonable time after receipt of the previously received offer. For example, such a message might be the following: “Be careful that if you wait too long (more than XX minutes, such as 15 minutes) before your next proposal, the negotiation might be stopped by the buyer”.

The next offer determination module 3033 might use buyer-dependant parameters stored in the buyer's equipment 10, in the database of buyers 306, including for example cookies produced by a web browser that might be useful for determining a buyer's profile, preferences of the specific buyer and history of negotiations of the specific buyer.

The next offer determination module 3033 might use seller-dependent parameters stored in the seller's equipment 20, in the database of buyers 2035, including for example cookies produced by a web browser that might be useful for determining a seller's profile, preferences of the specific seller and/or history of negotiations of the specific seller.

In the above, it is considered a one-to-one automatic price negotiation method between one specific seller with one specific potential buyer for a specific object. This automatic one-to-one price negotiation method can be implemented in parallel and involve several negotiations running concurrently for the same object, between a one seller and two or more different potential buyers. In that latter case, the determination of the second and eventually third offer for the object price proposed to a first potential buyer is not dependent on the parallelly run negotiation(s) for the same object. In another embodiment, notably when the object proposed by the seller is unique, namely this object exists in only one specimen, the determination of the second and eventually third offer proposed to a first potential buyer is dependent on the parallel negotiation(s), for the same object proposed one or several other buyers at the same moment.

### Additional Features and Terminology

Depending on the embodiment, certain acts, events, or functions of any of the algorithms described herein can be performed in a different sequence, can be added, merged, or left out altogether (for example, not all described acts or events are necessary for the practice of the methods). Moreover, in certain embodiments, acts or events can be performed concurrently, for instance, through multi-threaded processing, interrupt processing, or multiple processors or processor cores or on other parallel architectures, rather than sequentially. In addition, different tasks or processes can be performed by different machines or computing systems that can function together.

The various illustrative logical blocks, modules, machines, transducers and algorithm steps described herein can be implemented as electronic hardware, computer software, or combinations of both. To clearly illustrate this interchangeability of hardware and software, various illustrative components, blocks, modules, computing platforms, machines and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

A server, module or engine can be based on software and hardware components. The hardware components may be based on any type of computer system, including, but not limited to, a computer system based on a microprocessor, a mainframe computer, a digital signal processor, a portable computing device, a physical or virtual server, a cloud based server, a hybrid system comprising processing power in a server as well as additional processing power in the cloud, or a computational engine within an appliance, to name a few.

A software module can comprise one or a plurality of software programs or agents executed by a server, hardware module or engine in order perform various operations on data.

The steps of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage. An example storage medium can be coupled to the processor such that the processor can read information from, and write information to, the storage medium. In the alternative, the storage medium can be integral to the processor. The storage medium can be volatile or non-volatile.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, units or states. Thus, such conditional language is not generally intended to imply that features, units or states are in any way required for one or more embodiments or that one or more embodiments necessarily include logic for deciding, with or without author input or prompting, whether these features, units or states are included or are to be performed in any particular embodiment. The terms “comprising,” “including,” “having,” and the like are synonymous and are used inclusively, in an open-ended fashion, and do not exclude additional units, features, acts, operations, and so forth. Also, the term “or” is used in its inclusive sense (and not in its exclusive sense) so that when used, for example, to connect a list of units, the term “or” means one, some, or all of the units in the list. Further, the term “each,” as used herein, in addition to having its ordinary meaning, can mean any subset of a set of units to which the term “each” is applied.

1. A computer-implemented method for the automatic negotiation of the price of an object proposed on an on-line web site by a seller to a potential buyer, comprising:
providing an online sale server controlled by said seller, said online sale server comprising a database of objects for sale, each object being associated in said database with object parameters, said online sale server being programmed for presenting on the Internet a web site with a list of said objects for sale;
providing to a plurality of sellers an application server distinct from said online sale server and programmed or trained for determining a buyer independent psychological price for an object, said psychological price being dependent on the sale price of said object during previous transactions, said application server including a buyer parameters database, said buyer parameters depending on buyers profiles and buyers history of negotiations and/or transactions with a plurality of said sellers
presenting on said web site a first offer for said object;
receiving on said web site a first proposal from the potential buyer for said object with a first price;
transmitting said first proposal to said application server;
retrieving in said application server buyer parameters corresponding to said potential buyer;
retrieving in said application server buyer-independent parameters including parameters of the object, parameters and price of other objects, and data from external sources;
determining in said application server a second offer for said object, wherein said second offer includes a second price higher than said first price, said second price being determined with an artificial intelligence engine based on said psychological price, on said buyer parameters including said buyer history of negotiations and/or transactions and on said buyer independent parameters;
proposing said second offer to said buyer;
receiving from said buyer a second proposal with a third price;
transmitting said second proposal to said application server;
determining in said application server a third offer for said object, wherein said third offer includes a fourth price for said object or for a modified object.

2. The method of claim 1, wherein said modified object being either an object different from said object, or said object with an additional object.

3. The method of claim 2, comprising a step of determining the price and/or the cost of said modified object.

4. The method of claim 1, wherein a second artificial intelligence engine trained with prices and parameters of other objects is used for determining said psychological price of said object depending on parameters of said object.

5. The method of claim 1, wherein said buyer dependant parameters include cookies stored in a buyer equipment.

6. The method of claim 1, comprising a step of classifying said potential buyer according to the type of negotiator he is, and determining said second and said third offer depending on said type of negotiator.

7. The method of claim 1, wherein the selection of said modified object is buyer-dependant.

8. The method of claim 1, wherein said buyer-independent parameters include parameters retrieved from external servers such as weather forecasts or agendas.

9. The method of claim 1, wherein said buyer-independent parameters include seller's dependent parameters, such as seller's profile, preferences of the specific seller and/or history of negotiations of the specific seller.

10. The method of claim 1, wherein each object is associated in said database with a floor price, and wherein the first offer presented on said web site is presented with a public price higher than said floor price and higher than said psychological price, and wherein the second price at which the object is offered for sale is lower than said public price.

11. The method of claim 1, wherein no public price is displayed initially with the first offer, and wherein the potential buyer is invited to propose his own price that the application server can either accept or refuse.

12. The method of claim 1, wherein the maximal number of iterations is limited to N iterations.

13. The method of claim 1, wherein the maximal number of iterations N can be determined independently by each seller.

14. The method of claim 1, comprising a step of executing a plug-in in said online sale server in order to communicate with said application server and to present said second and said third offer.

15. A computer program product including a program arranged for causing an application server to perform a method comprising the steps of:
determining a buyer independent psychological price for an object, said psychological price being dependent on the sale price of said object during previous transactions,
storing a buyer parameters database, said buyer parameters depending on buyers profiles and buyers history of negotiations and/or transactions with a plurality of said sellers
receiving a first proposal from a potential buyer for an object with a first price;
retrieving buyer parameters corresponding to said potential buyer;
retrieving buyer-independent parameters including parameters of the object, parameters and price of other objects, and data from external sources;
determining a second offer for said object, wherein said second offer includes a second price higher than said first price, said second price being determined with an artificial intelligence engine based on said psychological price and on said buyer parameters including said buyer history of negotiations and/or transactions and on said buyer independent parameters;
proposing said second offer;
receiving a second proposal with a third price;
determining a third offer for said object, wherein said third offer includes a fourth price for said object or for a modified object.

16. The computer program product of claim 15, further comprising a program code section arranged for causing said application server to communicate with plug-ins on seller web sites for displaying said prices and receiving said proposals.
